(19) United States
(12) Patent Application Publication
(10) Pub. No.: US 2026/0179863 A1
(43) Pub. Date: Jun. 25, 2026

(54) SWITCH DEVICE

(71) Applicants: Chunghui KANG, Taipei City (TW); Chihkuo CHUI, Taoyuan City (TW); Jui-Ling LEE, New Taipei City (TW)

(72) Inventors: Chunghui KANG, Taipei City (TW); Chihkuo CHUI, Taoyuan City (TW); Jui-Ling LEE, New Taipei City (TW)

(21) Appl. No.: 19/432,074

(22) Filed: Dec. 23, 2025

(30) Foreign Application Priority Data
Dec. 25, 2024 (TW) 113150777

(51) Int. Cl. H01H 13/14; H01H 13/02; H01H 13/04

(52) U.S. Cl. CPC H01H 13/14; H01H 13/023; H01H 13/04

(57) ABSTRACT

A switch device includes a lower cover, an upper cover, a sliding part, at least one elastic part, and a high resistance conductive plate. The lower cover is disposed on a circuit board. The upper cover is disposed on the lower cover. The upper cover and the lower cover form an accommodating space. The sliding part passes through the upper cover and is configured to slide relative to the upper cover along a direction. The at least one elastic part is located in the accommodating space. The high resistance conductive plate is connected to an end of the at least one elastic part. The high resistance conductive plate receives a pressing force from the sliding part and generates a deformation. The deformation enables a resistance value of the high resistance conductive plate to vary.

### CROSS-REFERENCE TO RELATED APPLICATION

This application claims priority to Taiwan Application Serial Number 113150777, filed Dec. 25, 2024, which is herein incorporated by reference in its entirety.

### BACKGROUND

### Field of Invention

The present invention relates to a switch device.

### Description of Related Art

Keys of a keyboard may be implemented using Hall-effect switches, optical switches, or mechanical switches. However, mechanical switches are unable to provide switch signals corresponding to states other than the pressed state and the non-pressed state.

Therefore, how to propose a switch device that can solve the aforementioned problems is one of the problems that the industry is currently eager to invest in research and development resources to solve.

### SUMMARY

In view of this, one purpose of the present disclosure is to provide a switch device that can solve the aforementioned problems.

In order to achieve the above objective, in accordance with an embodiment of the present disclosure, a switch device includes a lower cover, an upper cover, a sliding part, at least one elastic part, and a high resistance conductive plate. The lower cover is disposed on a circuit board. The upper cover is disposed on the lower cover. The upper cover and the lower cover form an accommodating space. The sliding part passes through the upper cover and is configured to slide relative to the upper cover along a direction. The at least one elastic part is disposed in the accommodating space. The high resistance conductive plate is connected to an end of the at least one elastic part. The high resistance conductive plate receives a pressing force from the sliding part and generates a deformation. The deformation enables a resistance value of the high resistance conductive plate to vary. The high resistance conductive plate generates a switch signal in response to the deformation. The deformation is related the resistance value of the high resistance conductive plate.

In one or more embodiments of the present disclosure, the switch device further includes a light emitting unit located on the circuit board.

In one or more embodiments of the present disclosure, the other end of the at least one elastic part is connected to the lower cover.

In one or more embodiments of the present disclosure, the sliding part includes a pressing portion and an abutting portion connected to the pressing portion. The abutting portion is configured to abut against the high resistance conductive plate, such that the high resistance conductive plate generates the deformation.

In one or more embodiments of the present disclosure, the pressing portion passes through a through hole of the high resistance conductive plate. The abutting portion is located over the high resistance conductive plate.

In one or more embodiments of the present disclosure, the at least one elastic part includes two springs. The through hole is located between the two springs.

In one or more embodiments of the present disclosure, the high resistance conductive plate is located between the at least one elastic part and the sliding part.

In one or more embodiments of the present disclosure, the other end of the at least one elastic part is connected to the sliding part.

In one or more embodiments of the present disclosure, the sliding part includes a pressing portion and an abutting portion connected to the pressing portion. The abutting portion is configured to abut against the high resistance conductive plate by the at least one elastic part, such that the high resistance conductive plate generates the deformation.

In one or more embodiments of the present disclosure, the abutting portion is located over the high resistance conductive plate.

In one or more embodiments of the present disclosure, the sliding part further includes a shaft body connected to the abutting portion. The shaft body passes through the at least one elastic part.

In one or more embodiments of the present disclosure, the high resistance conductive plate includes two supporting portions disposed on the lower cover and a deforming portion connected between the two supporting portions. The sliding part abuts against the deforming portion by the at least one elastic part.

In one or more embodiments of the present disclosure, the deforming portion is connected to a top portion of the two supporting portions.

In order to achieve the above objective, in accordance with an embodiment of the present disclosure, a switch device includes a lower cover, an upper cover, a sliding part, at least one elastic part, and a high resistance conductive plate. The lower cover is disposed on a circuit board. The upper cover is disposed on the lower cover. The upper cover and the lower cover form an accommodating space. The sliding part passes through the upper cover and is configured to slide relative to the upper cover along a direction. The at least one elastic part is located in the accommodating space. The high resistance conductive plate is connected to an end of the at least one elastic part. The high resistance conductive plate receives a pressing force from the sliding part and generates a deformation. The deformation enables a resistance value of the high resistance conductive plate to vary. The high resistance conductive plate generates a switch signal in response to the deformation. The switch signal is between a pressed state and a non-pressed state.

In one or more embodiments of the present disclosure, the sliding part includes a pressing portion and an abutting portion connected to the pressing portion. The abutting portion is configured to abut against the high resistance conductive plate, such that the high resistance conductive plate generates the deformation.

In one or more embodiments of the present disclosure, the pressing portion passes through a through hole of the high resistance conductive plate. The abutting portion is located over the high resistance conductive plate.

In one or more embodiments of the present disclosure, the sliding part includes a pressing portion and an abutting portion connected to the pressing portion. The abutting portion is configured to abut against the high resistance conductive plate by the at least one elastic part, such that the high resistance conductive plate generates the deformation.

In one or more embodiments of the present disclosure, the abutting portion is located over the high resistance conductive plate.

In one or more embodiments of the present disclosure, the high resistance conductive plate includes two supporting portions disposed on the lower cover and a deforming portion connected between the two supporting portions. The sliding part abuts against the deforming portion by the at least one elastic part.

In one or more embodiments of the present disclosure, the deforming portion is connected to a top portion of the two supporting portions.

In summary, in the switch device of the present disclosure, since the high resistance conductive plate changes its resistance value in response to the deformation, a switch signal corresponding to the resistance value can be generated when the high resistance conductive plate receives a pressing force and generates a deformation. In the switch device of the present disclosure, since the high resistance conductive plate has a through hole through which the pressing portion of the sliding part passes, when the sliding part receives a pressing force to slide downward and the abutting portion abuts against the high resistance conductive plate, the sliding part can more stably slide relative to the upper cover without detaching therefrom. In the switch device of the present disclosure, since the deforming portion is connected to the top portion of the two supporting portions, when the sliding part enables the deforming portion to deform by the elastic part, the deforming portion may have a greater deformation space, thereby generating a switch signal with a greater variation. Accordingly, the switch device of the present disclosure, compared to conventional mechanical switches that can only produce binary switch signals corresponding to pressed and non-pressed states, is capable of generating switch signals located between the pressed state and the non-pressed state, thereby enhancing the flexibility and applicability of keyboard keys in the field of e-sports.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is an exploded view of a switch device in accordance with an embodiment of the present disclosure;

FIG. 2 is a schematic cross-sectional view of the switch device in accordance with an embodiment of the present disclosure;

FIG. 3 is a cross-sectional view of the switch device in accordance with an embodiment of the present disclosure;

FIG. 4 is an exploded view of a switch device in accordance with an embodiment of the present disclosure;

FIG. 5 is a schematic cross-sectional view of the switch device in accordance with an embodiment of the present disclosure;

FIG. 6 is a cross-sectional view of the switch device in accordance with an embodiment of the present disclosure;

FIG. 7 is an exploded view of a switch device in accordance with an embodiment of the present disclosure;

FIG. 8 is a schematic cross-sectional view of the switch device in accordance with an embodiment of the present disclosure; and

FIG. 9 is a cross-sectional view of the switch device in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a switch device 100 of this embodiment and the connection relationship between the components will be described in detail.

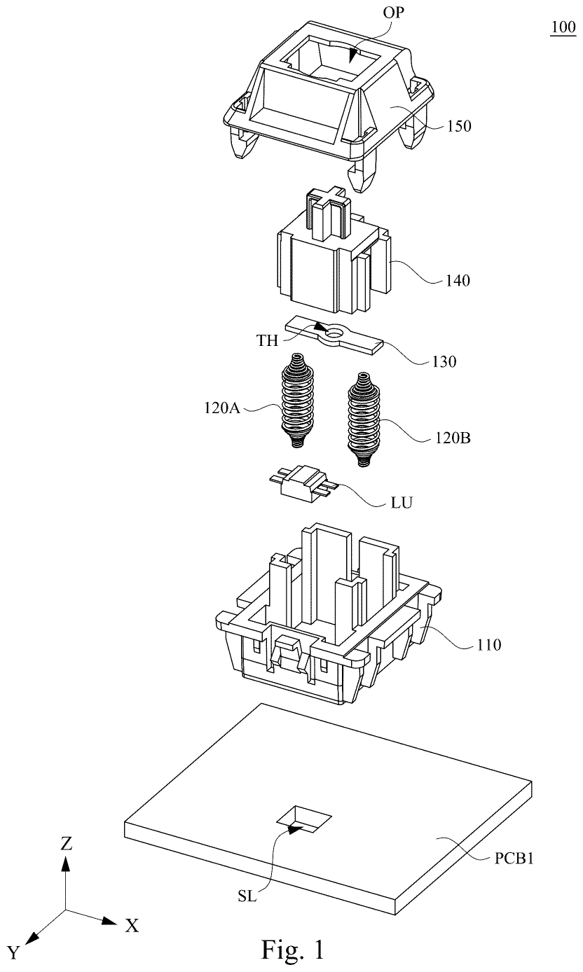

Reference is made to FIG. 1. FIG. 1 is an exploded view of a switch device 100 in accordance with an embodiment of the present disclosure. As shown in FIG. 1, in this embodiment, the switch device 100 includes a circuit board PCB1, a lower cover 110, a light emitting unit LU, an elastic part 120A, an elastic part 120B, a high resistance conductive plate 130, a sliding part 140, and an upper cover 150. The circuit board PCB1 has a slot SL. The light emitting unit LU is located on the circuit board PCB1. Specifically, the light emitting unit LU is located in the slot SL of the circuit board PCB1, and the light emitting unit LU is electrically connected to the circuit board PCB1. The lower cover 110 is disposed on the circuit board PCB1. As shown in FIG. 1, the circuit board PCB1, the lower cover 110, the elastic part 120A and the elastic part 120B, the high resistance conductive plate 130, the sliding part 140, and the upper cover 150 are sequentially arranged from bottom to top. For example, the circuit board PCB1, the lower cover 110, the elastic part 120A and the elastic part 120B, the high resistance conductive plate 130, the sliding part 140, and the upper cover 150 are sequentially arranged along a Z direction. As shown in FIG. 1, the high resistance conductive plate 130 has a through hole TH.

As shown in FIG. 1, in some embodiments, the elastic part 120A and the elastic part 120B are arranged in a direction (e.g., X direction).

In some embodiments, the switch device 100 is configured to constitute a key of a keyboard and is configured to generate switch signals corresponding to two states, namely, a non-pressed state and a pressed state.

In some embodiments, the circuit board PCB1 may be, for example, a printed circuit board (PCB).

In some embodiments, the sliding part 140 is configured to receive a pressing operation from a user. Specifically, the user may apply a pressing force to the sliding part 140 to actuate the sliding part 140.

In some embodiments, the materials of the lower cover 110, the sliding part 140, and the upper cover 150 may include, for example, plastic or other suitable insulating materials.

In some embodiments, the materials of the elastic part 120A and the elastic part 120B may include, for example, metal or other suitable conductive materials.

In some embodiments, the elastic part 120A and the elastic part 120B may be, for example, springs or other suitable elastic materials. In other words, the switch device 100 of the present disclosure adopts a dual-spring configuration.

In some embodiments, the material of the high resistance conductive plate 130 may include, for example, an insulating material doped with metal ions or other suitable high resistance conductive materials. In some embodiments, the material of the high resistance conductive plate 130 may be a piezoresistive material (e.g., carbon/graphene/carbon nanotube composite, polysilicon, or other suitable piezoresistive materials), a conductive polymer material, a metal oxide thin film, a piezoelectric/piezoresistive hybrid material (e.g., piezoelectric ceramics), liquid metal or mixtures thereof (e.g., gallium alloy mixed with an elastomer), or other suitable materials.

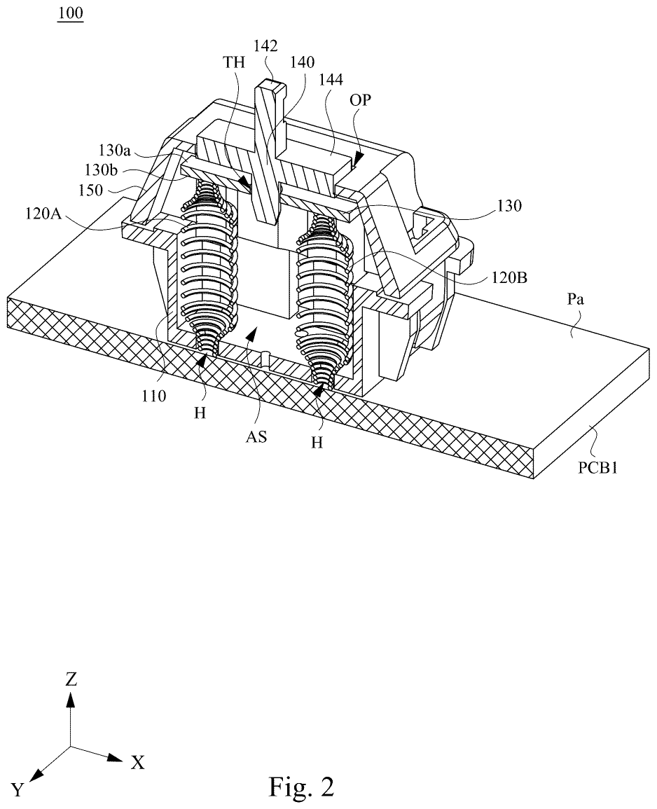

Reference is made to FIG. 2. FIG. 2 is a schematic cross-sectional view of the switch device 100 in accordance with an embodiment of the present disclosure. As shown in FIG. 2, in this embodiment, the lower cover 110 is disposed on the circuit board PCB1. Specifically, the circuit board PCB1 has a top surface Pa. The lower cover 110 is disposed on the top surface Pa of the circuit board PCB1. The upper cover 150 is disposed on the lower cover 110. In some embodiments, the lower cover 110 is engaged with the upper cover 150. The upper cover 150 and the lower cover 110 are combined to form an accommodating space AS. The sliding part 140 passes through the upper cover 150. Specifically, the upper cover 150 has an opening OP. The sliding part 140 passes through the opening OP. In some embodiments, the sliding part 140 is partially located in the accommodating space AS formed by the upper cover 150 and the lower cover 110. The sliding part 140 is configured to slide relative to the upper cover 150 along a direction. For example, the sliding part 140 slides relative to the upper cover 150 along the Z direction. The elastic part 120A and the elastic part 120B are located in the accommodating space AS. In some embodiments, the elastic part 120A and the elastic part 120B are elastically stretched along a direction (e.g., Z direction). The high resistance conductive plate 130 is connected to an end of the elastic part 120A and an end of the elastic part 120B. Specifically, each of the elastic part 120A and the elastic part 120B has an upper end and a lower end. The high resistance conductive plate 130 is connected to the upper end of the elastic part 120A and the upper end the elastic part 120B. The lower end of the elastic part 120A and the lower end of the elastic part 120B are connected to the circuit board PCB1. In some embodiments, the lower cover 110 has a plurality of holes H corresponding to the elastic part 120A and the elastic part 120B. For example, the lower end of the elastic part 120A passes through a hole H of the lower cover 110, and the lower end of the elastic part 120B passes through another hole H of the lower cover 110. In other words, the two ends of the elastic part 120A are respectively connected to the lower cover 110 and the high resistance conductive plate 130. Similarly, the two ends of the elastic part 120B are also respectively connected to the lower cover 110 and the high resistance conductive plate 130.

Reference is made again to FIG. 2. As shown in FIG. 2, in this embodiment, the high resistance conductive plate 130 is located between the elastic part 120A and the sliding part 140, and the high resistance conductive plate 130 is also located between the elastic part 120B and the sliding part 140. The elastic part 120A and the elastic part 120B are located between the high resistance conductive plate 130 and the lower cover 110. The through hole TH of the high resistance conductive plate 130 is located between the elastic part 120A and the elastic part 120B. The sliding part 140 is disposed on the high resistance conductive plate 130. Specifically, the sliding part 140 includes a pressing portion 142 and an abutting portion 144. The pressing portion 142 is configured to be coupled with an additional keycap (not shown). The abutting portion 144 is connected to the pressing portion 142. In some embodiments, the abutting portion 144 is in the form of a flat plate, and the pressing portion 142 is substantially located at the center of the abutting portion 144. The abutting portion 144 is configured to abut against the high resistance conductive plate 130, such that the high resistance conductive plate 130 generates a deformation.

In some embodiments, the pressing portion 142 passes through the through hole TH of the high resistance conductive plate 130, and the abutting portion 144 is located over the high resistance conductive plate 130.

In some embodiments, the high resistance conductive plate 130 has a top surface 130a and a bottom surface 130b. As shown in FIG. 2, the upper end of the elastic part 120A and the upper end of the elastic part 120B abut against the bottom surface 130b of the high resistance conductive plate 130. The abutting portion 144 of the sliding part 140 is configured to abut against the top surface 130a of the high resistance conductive plate 130.

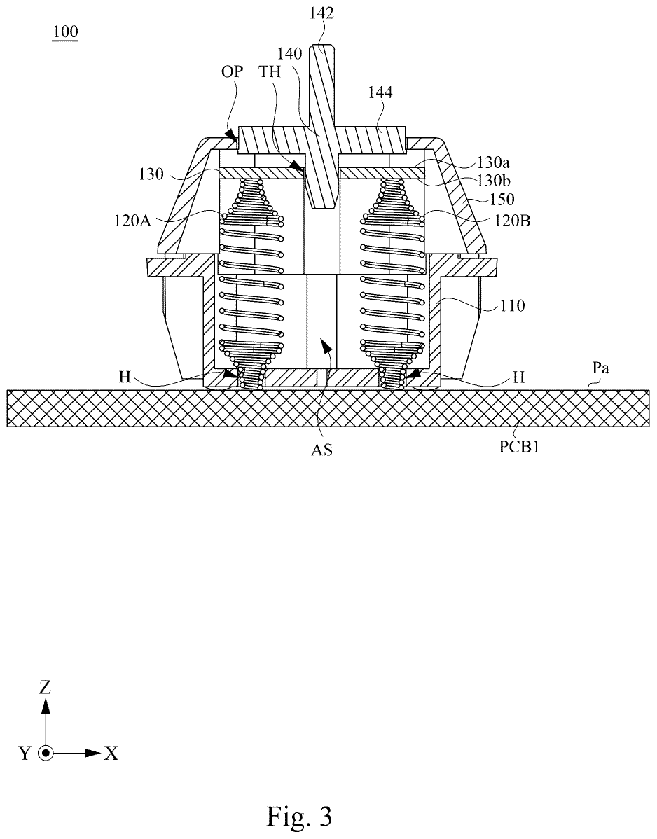

Reference is made to FIG. 3. FIG. 3 is a cross-sectional view of the switch device 100 in accordance with an embodiment of the present disclosure. FIG. 3 is in a view along a Y direction. As shown in FIG. 3, in this embodiment, the high resistance conductive plate 130 receives a pressing force from the sliding part 140 and generates a deformation. The deformation enables a resistance value of the high resistance conductive plate 130 to vary. Therefore, the high resistance conductive plate 130 generates a switch signal in response to the deformation, and the deformation is related to the resistance value of the high resistance conductive plate 130. More specifically, when the high resistance conductive plate 130 is stretched under pressure, the resistance value of the high resistance conductive plate 130 increases. In contrast, when the high resistance conductive plate 130 returns to its original shape after the pressure is released, the resistance value of the high resistance conductive plate 130 decreases. Therefore, switch signals of different magnitudes, located between a non-pressed state and a pressed state, may be generated based on different degrees of deformation of the high resistance conductive plate 130.

In a usage scenario, when the user does not press the sliding part 140, the high resistance conductive plate 130 does not receive a pressing force from the sliding part 140 and thus does not generate a deformation, and the resistance value of the high resistance conductive plate 130 remains constant. Hence, when the user does not press the sliding part 140, the switch device 100 does not generate a switch signal. In a usage scenario, when the user presses the sliding part 140, the sliding part 140 slides downward relative to the upper cover 150 in a direction (e.g., Z direction). Since the high resistance conductive plate 130 receives a pressing force from the sliding part 140, the high resistance conductive plate 130 generates a deformation, causing the resistance value of the high resistance conductive plate 130 to change. Specifically, when the high resistance conductive plate 130 receives a pressing force from the sliding part 140, a periphery (i.e., a portion of the high resistance conductive plate 130 beyond the abutting portion 144) of the high resistance conductive plate 130 bends upward, thereby resulting in an increase in the resistance value of the high resistance conductive plate 130. Hence, when the user presses the sliding part 140, the switch device 100 generates a switch signal.

In some embodiments, the sliding part 140 further includes a bump (not shown) disposed between the abutting portion 144 and the high resistance conductive plate 130. In some embodiments, a diameter of the bump is greater than a diameter of the through hole TH. The configuration of the bump facilitates the deformation of the high resistance conductive plate 130 when being pressed.

Hereinafter, the structure and function of each component included in a switch device 200 of this embodiment and the connection relationship between the components will be described in detail.

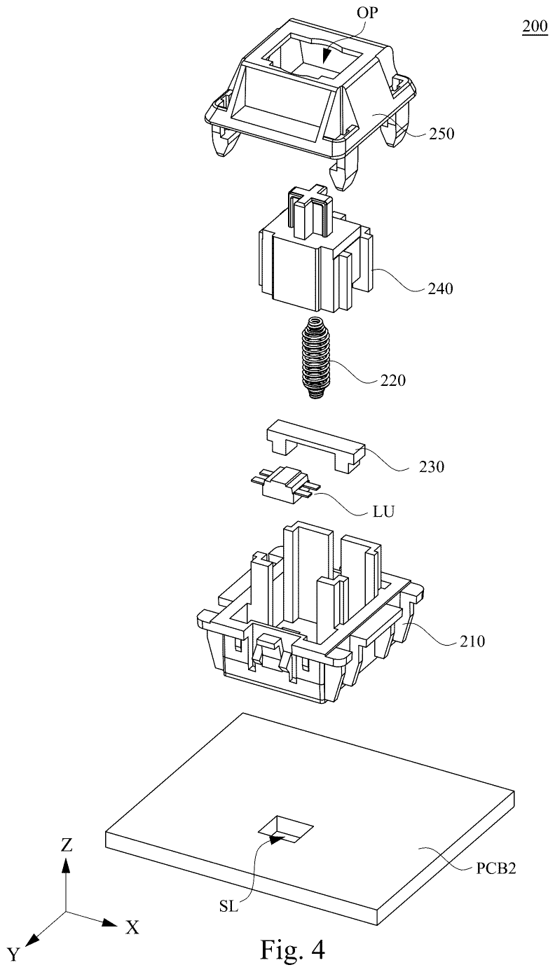

Reference is made to FIG. 4. FIG. 4 is an exploded view of a switch device 200 in accordance with an embodiment of the present disclosure. As shown in FIG. 4, in this embodiment, the switch device 200 includes a circuit board PCB2, a lower cover 210, a light emitting unit LU, an elastic part 220, a high resistance conductive plate 230, a sliding part 240, and an upper cover 250. The circuit board PCB2 has a slot SL. The light emitting unit LU is located on the circuit board PCB2. Specifically, the light emitting unit LU is located in the slot SL of the circuit board PCB2, and the light emitting unit LU is electrically connected to the circuit board PCB2. The lower cover 210 is disposed on the circuit board PCB2. As shown in FIG. 4, the circuit board PCB2, the lower cover 210, the high resistance conductive plate 230, the elastic part 220, the sliding part 240, and the upper cover 250 are sequentially arranged from bottom to top. For example, the circuit board PCB2, the lower cover 210, the high resistance conductive plate 230, the elastic part 220, the sliding part 240, and the upper cover 250 are sequentially arranged along the Z direction.

In some embodiments, the switch device 200 is configured to constitute a key of a keyboard and is configured to generate switch signals corresponding to two states, namely, a non-pressed state and a pressed state.

In some embodiments, the circuit board PCB2 may be, for example, a printed circuit board (PCB).

In some embodiments, the sliding part 240 is configured to receive a pressing operation from a user. Specifically, the user may apply a pressing force to the sliding part 240 to actuate the sliding part 240.

In some embodiments, the materials of the lower cover 210, the sliding part 240, and the upper cover 250 may include, for example, plastic or other suitable insulating materials.

In some embodiments, the material of the elastic part 220 may include, for example, metal or other suitable conductive materials.

In some embodiments, the elastic part 220 may be, for example, a spring or other suitable elastic material. In other words, the switch device 200 of the present disclosure adopts a single-spring configuration.

In some embodiments, the material of the high resistance conductive plate 230 may include, for example, an insulating material doped with metal ions or other suitable high resistance conductive materials. In some embodiments, the material of the high resistance conductive plate 230 may be a piezoresistive material (e.g., carbon/graphene/carbon nanotube composite, polysilicon, or other suitable piezoresistive materials), a conductive polymer material, a metal oxide thin film, a piezoelectric/piezoresistive hybrid material (e.g., piezoelectric ceramics), liquid metal or mixtures thereof (e.g., gallium alloy mixed with an elastomer), or other suitable materials.

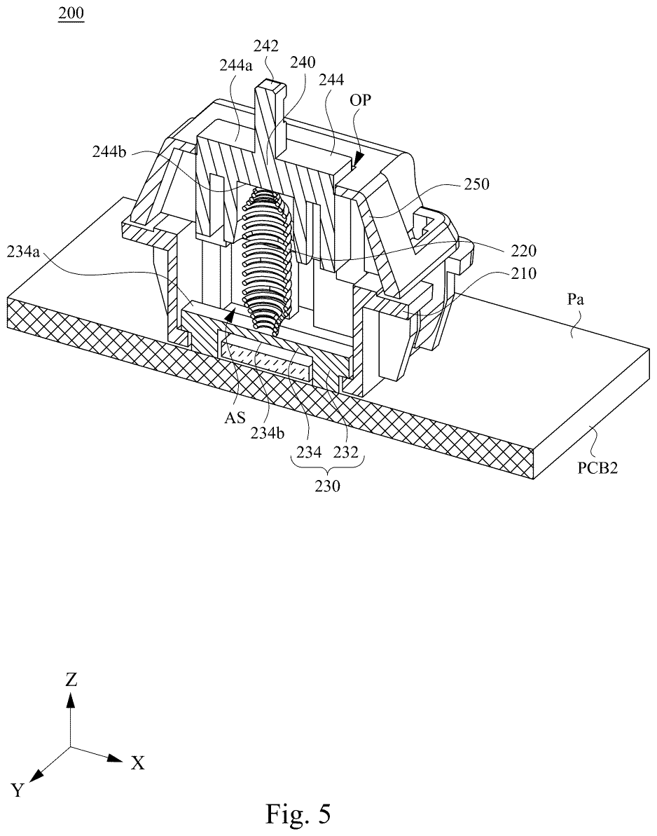

Reference is made to FIG. 5. FIG. 5 is a schematic cross-sectional view of the switch device 200 in accordance with an embodiment of the present disclosure. As shown in FIG. 5, in this embodiment, the lower cover 210 is disposed on the circuit board PCB2. Specifically, the circuit board PCB2 has a top surface Pa. The lower cover 210 is disposed on the top surface Pa of the circuit board PCB2. The upper cover 250 is disposed on the lower cover 210. In some embodiments, the lower cover 210 is engaged with the upper cover 250. The upper cover 250 and the lower cover 210 are combined to form an accommodating space AS. The sliding part 240 passes through the upper cover 250. Specifically, the upper cover 250 has an opening OP. The sliding part 240 passes through the opening OP. In some embodiments, the sliding part 240 is partially located in the accommodating space AS formed by the upper cover 250 and the lower cover 210. The sliding part 240 is configured to slide relative to the upper cover 250 along a direction. For example, the sliding part 240 slides relative to the upper cover 250 along the Z direction. The elastic part 220 is located in the accommodating space AS. In some embodiments, the elastic part 220 is elastically stretched along a direction (e.g., Z direction). The high resistance conductive plate 230 is disposed on the lower cover 210. The high resistance conductive plate 230 is connected to an end of the elastic part 220. Specifically, the elastic part 220 has an upper end and a lower end. The high resistance conductive plate 230 is connected to the lower end of the elastic part 220. The upper end of the elastic part 220 is connected to the sliding part 240. In other words, two ends of the elastic part 220 are respectively connected to the high resistance conductive plate 230 and the sliding part 240.

Reference is made again to FIG. 5. As shown in FIG. 5, in this embodiment, the high resistance conductive plate 230 includes supporting portions 232 and a deforming portion 234. Specifically, the high resistance conductive plate 230 includes two supporting portions 232. The two supporting portions 232 are disposed on the lower cover 210. The deforming portion 234 is connected between the two supporting portions 232. In some embodiments, the deforming portion 234 is connected to a top portion of the two supporting portions 232. The elastic part 220 is located between the high resistance conductive plate 230 and the sliding part 240. The sliding part 240 abuts against the deforming portion 234 by the elastic part 220. In some embodiments, the deforming portion 234 has a top surface 234a and a bottom surface 234b, and the lower end of the elastic part 220 abuts against the top surface 234a of the deforming portion 234. The sliding part 240 includes a pressing portion 242 and an abutting portion 244. The pressing portion 242 is configured to be coupled with an additional keycap (not shown). The abutting portion 244 is connected to the pressing portion 242. In some embodiments, the abutting portion 244 has a top surface 244a and a bottom surface 244b, and the upper end of the elastic part 220 abuts against the bottom surface 244b of the abutting portion 244. The abutting portion 244 of the sliding part 240 abuts against the deforming portion 234 of the high resistance conductive plate 230 by the elastic part 220, such that the high resistance conductive plate 230 generates a deformation. Specifically, the deforming portion 234 is suspended relative to the lower cover 210. The bottom surface 234b of the deforming portion 234 is separated from a portion of the lower cover 210 connected to the circuit board PCB2 by a distance. Therefore, when the sliding part 240 abuts against the deforming portion 234 by the elastic part 220, the deforming portion 234 has a greater deformation space.

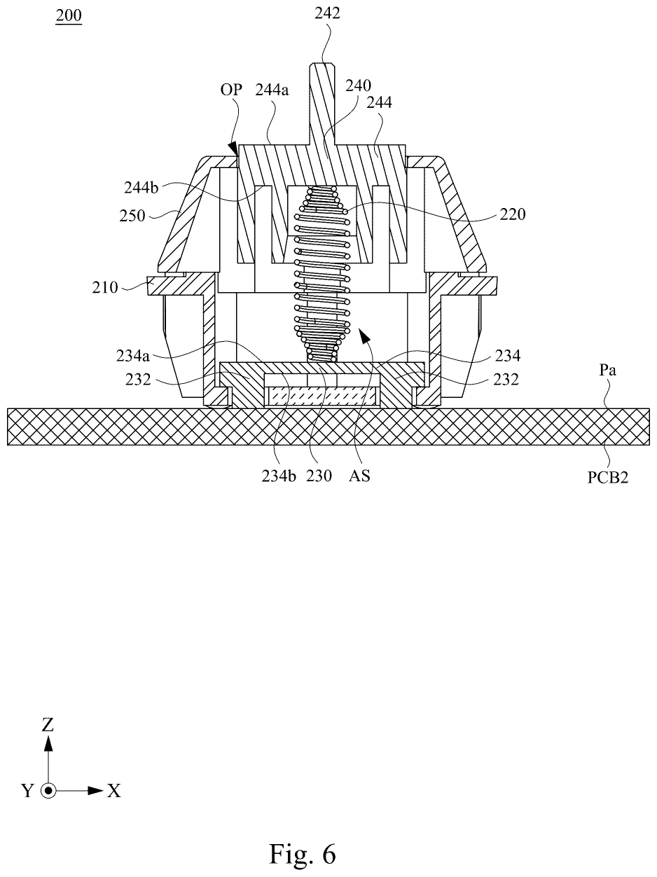

Reference is made to FIG. 6. FIG. 6 is a cross-sectional view of the switch device 200 in accordance with an embodiment of the present disclosure. FIG. 6 is in a view along a Y direction. As shown in FIG. 6, in this embodiment, the high resistance conductive plate 230 receives a pressing force from the sliding part 240 and generates a deformation. The deformation causes a change in a resistance value of the high resistance conductive plate 230. Therefore, the high resistance conductive plate 230 generates a switch signal in response to the deformation, and the deformation is related to the resistance value of the high resistance conductive plate 230. More specifically, when the deforming portion 234 of the high resistance conductive plate 230 is bent and elongated under pressure, the resistance value of the high resistance conductive plate 230 increases. In contrast, when the high resistance conductive plate 230 returns to its original shape after the pressure is released, the resistance value of the high resistance conductive plate 230 decreases. Therefore, switch signals of different magnitudes, located between a non-pressed state and a pressed state, may be generated based on different degrees of deformation of the high resistance conductive plate 230.

In a usage scenario, when the user does not press the sliding part 240, the high resistance conductive plate 230 does not receive a pressing force from the sliding part 240 and thus does not generate a deformation, and the resistance value of the high resistance conductive plate 230 remains constant. Hence, when the user does not press the sliding part 240, the switch device 200 does not generate a switch signal. In a usage scenario, when the user presses the sliding part 240, the sliding part 240 slides downward relative to the upper cover 250 in a direction (e.g., Z direction). Since the deforming portion 234 of the high resistance conductive plate 230 receives a pressing force from the sliding part 240, the deforming portion 234 generates a deformation, causing the resistance value of the high resistance conductive plate 230 to change. Specifically, when the high resistance conductive plate 230 receives a pressing force from the sliding part 240, the deforming portion 234 bends and becomes elongated, thereby resulting in an increase in the resistance value of the high resistance conductive plate 230. Hence, when the user presses the sliding part 240, the switch device 200 generates a switch signal.

Hereinafter, the structure and function of each component included in a switch device 300 of this embodiment and the connection relationship between the components will be described in detail.

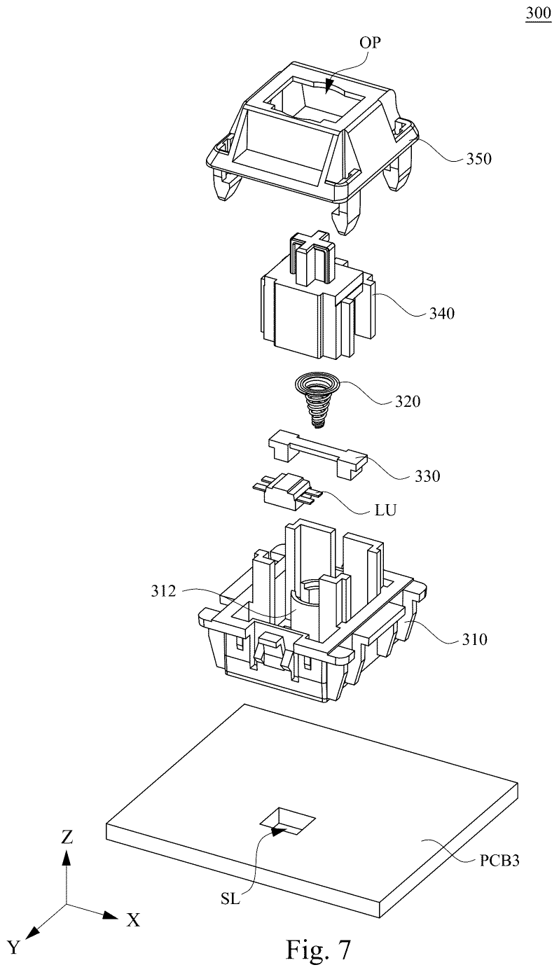

Reference is made to FIG. 7. FIG. 7 is an exploded view of a switch device 300 in accordance with an embodiment of the present disclosure. As shown in FIG. 7, in this embodiment, the switch device 300 includes a circuit board PCB3, a lower cover 310, a light emitting unit LU, a high resistance conductive plate 330, an elastic part 320, a sliding part 340, and an upper cover 350. The circuit board PCB3 has a slot SL. The light emitting unit LU is located on the circuit board PCB3. Specifically, the light emitting unit LU is located in the slot SL of the circuit board PCB3, and the light emitting unit LU is electrically connected to the circuit board PCB3. The lower cover 310 is disposed on the circuit board PCB3. As shown in FIG. 7, the circuit board PCB3, the lower cover 310, the high resistance conductive plate 330, the elastic part 320, the sliding part 340, and the upper cover 350 are sequentially arranged from bottom to top. For example, the circuit board PCB3, the lower cover 310, the high resistance conductive plate 330, the elastic part 320, the sliding part 340, and the upper cover 350 are sequentially arranged along the Z direction. The structural configuration of the switch device 300 is generally similar to the structural configuration of the switch device 200, the differences in between is that the lower cover 310 includes a sleeve 312. The sleeve 312 is configured to accommodate the elastic part 320. In addition, a shape of the elastic part 320 is different from a shape of the elastic part 220. The structural configuration of the switch device 300 will be described in more detail below.

In some embodiments, the switch device 300 is configured to constitute a key of a keyboard and is configured to generate switch signals corresponding to a non-pressed state and a pressed state.

In some embodiments, the circuit board PCB3 may be, for example, a printed circuit board (PCB).

In some embodiments, the sliding part 340 is configured to receive a pressing operation from a user. Specifically, the user may apply a pressing force to the sliding part 340 to actuate the sliding part 340.

In some embodiments, the materials of the lower cover 310, the sliding part 340, and the upper cover 350 may include, for example, plastic or other suitable insulating materials.

In some embodiments, the material of the elastic part 320 may include, for example, metal or other suitable conductive materials.

In some embodiments, the elastic part 320 may be, for example, a spring or other suitable elastic material. In other words, similar to the switch device 200, the switch device 300 of the present disclosure also adopts a single-spring configuration.

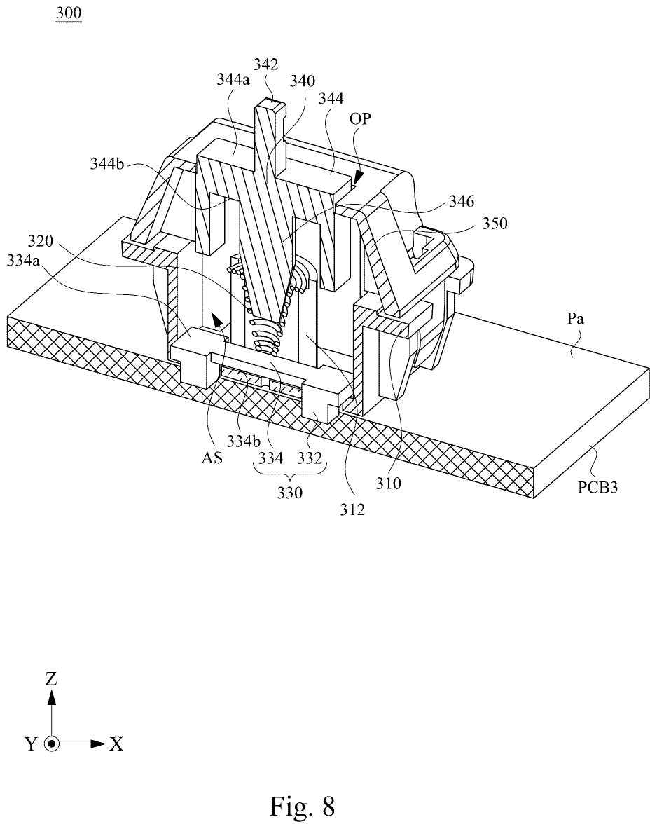

In some embodiments, the elastic part 320 has a funnel shape. In some embodiments in which the elastic part 320 is funnel-shaped, a tip end of the elastic part 320 has a greater amount of stretch and contract than a blunt end of the elastic part 320. As shown in FIG. 8, the tip end of the elastic part 320 refers to a lower end of the elastic part 320, and the blunt end refers to an upper end of the elastic part 320.

In some embodiments, the material of the high resistance conductive plate 330 may include, for example, an insulating material doped with metal ions or other suitable high resistance conductive materials. In some embodiments, the material of the high resistance conductive plate 330 may be a piezoresistive material (e.g., carbon/graphene/carbon nanotube composite, polysilicon, or other suitable piezoresistive materials), a conductive polymer material, a metal oxide thin film, a piezoelectric/piezoresistive hybrid material (e.g., piezoelectric ceramics), liquid metal or mixtures thereof (e.g., gallium alloy mixed with an elastomer), or other suitable materials.

Reference is made to FIG. 8. FIG. 8 is a schematic cross-sectional view of the switch device 300 in accordance with an embodiment of the present disclosure. Although the high resistance conductive plate 330 goes through the section, it will be illustrated in its entirety for clarity. As shown in FIG. 8, in this embodiment, the lower cover 310 is disposed on the circuit board PCB3. Specifically, the circuit board PCB3 has a top surface Pa. The lower cover 310 is disposed on the top surface Pa of the circuit board PCB3. The upper cover 350 is disposed on the lower cover 310. In some embodiments, the lower cover 310 is engaged with the upper cover 350. The upper cover 350 and the lower cover 310 are combined to form an accommodating space AS. The sliding part 340 passes through the upper cover 350. Specifically, the upper cover 350 has an opening OP. The sliding part 340 passes through the opening OP. In some embodiments, the sliding part 340 is partially located in the accommodating space AS formed by the upper cover 350 and the lower cover 310. The sliding part 340 is configured to slide relative to the upper cover 350 along a direction. For example, the sliding part 340 slides relative to the upper cover 350 along the Z direction. The elastic part 320 is located in the accommodating space AS. In some embodiments, the elastic part 320 is elastically stretched along a direction (e.g., Z direction). More specifically, an upper end of the elastic part 320 is fixed to a top portion of the sleeve 312, such that a middle portion and a lower end of the sleeve 312 are elastically stretched along the Z direction. The high resistance conductive plate 330 is disposed on the lower cover 310. The high resistance conductive plate 330 is connected to an end of the elastic part 320. Specifically, the high resistance conductive plate 330 is connected to a lower end of the elastic part 320. An upper end of the elastic part 320 is connected to the sliding part 340. More specifically, a portion of the sliding part 340 passes through the elastic part 320 from the upper end of the elastic part 320. The lower end of the elastic part 320 abuts against the high resistance conductive plate 330.

Reference is made again to FIG. 8. As shown in FIG. 8, in this embodiment, the high resistance conductive plate 330 includes supporting portions 332 and a deforming portion 334. Specifically, the high resistance conductive plate 330 includes two supporting portions 332. The two supporting portions 332 are disposed on the lower cover 310. The deforming portion 334 is connected between the two supporting portions 332. In some embodiments, the deforming portion 334 is connected to a top portion of the two supporting portions 332. The elastic part 320 is located between the high resistance conductive plate 330 and the sliding part 340. The sliding part 340 abuts against the deforming portion 334 by the elastic part 320. In some embodiments, the deforming portion 334 has a top surface 334a and a bottom surface 334b, and the lower end of the elastic part 320 abuts against the top surface 334a of the deforming portion 334. The sliding part 340 includes a pressing portion 342, an abutting portion 344, and a shaft body 346. The pressing portion 342 is configured to be coupled with an additional keycap (not shown). The abutting portion 344 is connected to the pressing portion 342. The shaft body 346 is connected to the abutting portion 344. In other words, the pressing portion 342 and the shaft body 346 are respectively disposed on opposite sides of the abutting portion 344. In some embodiments, the abutting portion 344 has a top surface 344a and a bottom surface 344b. In some embodiments, the pressing portion 342 is disposed on the top surface 344a of the abutting portion 344, and the shaft body 346 is disposed on the bottom surface 344b of the abutting portion 344. In some embodiments, the shaft body 346 protrudes from the abutting portion 344 and is elongated in a sliding direction of the sliding part 340. As shown in FIG. 8, the shaft body 346 passes through the elastic part 320. The shaft body 346 of the sliding part 340 abuts against the deforming portion 334 of the high resistance conductive plate 330 by the elastic part 320, such that the high resistance conductive plate 330 generates a deformation. Specifically, the deforming portion 334 is suspended relative to the lower cover 310. The bottom surface 334b of the deforming portion 334 is separated from a portion of the lower cover 310 connected to the circuit board PCB3 by a distance. Therefore, when the sliding part 340 abuts against the deforming portion 334 by the elastic part 320, the deforming portion 334 has a greater deformation space.

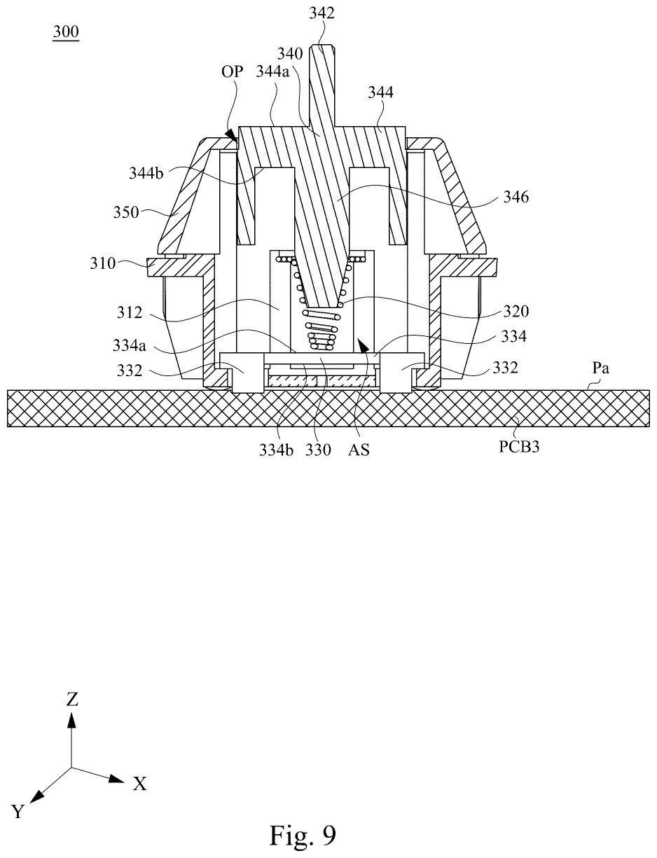

Reference is made to FIG. 9. FIG. 9 is a cross-sectional view of the switch device 300 in accordance with an embodiment of the present disclosure. FIG. 9 is in a view along a Y direction. As shown in FIG. 9, in this embodiment, the high resistance conductive plate 330 receives a pressing force from the sliding part 340 and generates a deformation. The deformation causes a change in a resistance value of the high resistance conductive plate 330. Therefore, the high resistance conductive plate 330 generates a switch signal in response to the deformation, and the deformation is related to the resistance value of the high resistance conductive plate 330. More specifically, when the deforming portion 334 of the high resistance conductive plate 330 is bent and elongated under pressure, the resistance value of the high resistance conductive plate 330 increases. In contrast, when the high resistance conductive plate 330 returns to its original shape after the pressure is released, the resistance value of the high resistance conductive plate 330 decreases. Therefore, switch signals of different magnitudes, located between a non-pressed state and a pressed state, may be generated based on different degrees of deformation of the high resistance conductive plate 330.

In a usage scenario, when the user does not press the sliding part 340, the high resistance conductive plate 330 does not receive a pressing force from the sliding part 340 and thus does not generate a deformation, and the resistance value of the high resistance conductive plate 330 remains constant. Hence, when the user does not press the sliding part 340, the switch device 300 does not generate a switch signal. In a usage scenario, when the user presses the sliding part 340, the sliding part 340 slides downward relative to the upper cover 350 in a direction (e.g., Z direction). Next, the shaft body 346 of the sliding part 340, which passes through the elastic part 320, moves toward the high resistance conductive plate 330, such that the elastic part 320 stretches downward. Specifically, when the shaft body 346 drives the elastic part 320 downward, since the upper end (i.e., the blunt end) of the elastic part 320 is fixed to the top portion of the sleeve 312, the middle portion and the lower end (i.e., the tip end) of the elastic part 320 are driven downward by the shaft body 346. Since the deforming portion 334 of the high resistance conductive plate 330 receives a pressing force from the sliding part 340, the deforming portion 334 of the high resistance conductive plate 330 generates a deformation, causing the resistance value of the high resistance conductive plate 330 to change. Specifically, when the high resistance conductive plate 330 receives a pressing force from the sliding part 340, the deforming portion 334 is bent and becomes elongated, thereby resulting in an increase in the resistance value of the high resistance conductive plate 330. Hence, when the user presses the sliding part 340, the switch device 300 generates a switch signal.

From the above detailed description of the specific embodiments of the present disclosure, it can be clearly seen that in the switch device of the present disclosure, since the high resistance conductive plate changes its resistance value in response to the deformation, a switch signal corresponding to the resistance value can be generated when the high resistance conductive plate receives a pressing force and generates a deformation. In the switch device of the present disclosure, since the high resistance conductive plate has a through hole through which the pressing portion of the sliding part passes, when the sliding part receives a pressing force to slide downward and the abutting portion abuts against the high resistance conductive plate, the sliding part can more stably slide relative to the upper cover without detaching therefrom. In the switch device of the present disclosure, since the deforming portion is connected to the top portion of the two supporting portions, when the sliding part enables the deforming portion to deform by the elastic part, the deforming portion may have a greater deformation space, thereby generating a switch signal with a greater variation. Accordingly, the switch device of the present disclosure, compared to conventional mechanical switches that can only produce binary switch signals corresponding to pressed and non-pressed states, is capable of generating switch signals located between the pressed state and the non-pressed state, thereby enhancing the flexibility and applicability of keyboard keys in the field of e-sports.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A switch device, comprising:
a lower cover disposed on a circuit board;
an upper cover disposed on the lower cover, and the upper cover and the lower cover forming an accommodating space;
a sliding part passing through the upper cover and configured to slide relative to the upper cover along a direction;
at least one elastic part disposed in the accommodating space; and
a high resistance conductive plate connected to an end of the at least one elastic part, and the high resistance conductive plate receiving a pressing force from the sliding part and generating a deformation, wherein the deformation enables a resistance value of the high resistance conductive plate to vary,
wherein the high resistance conductive plate generates a switch signal in response to the deformation, and the deformation is related to the resistance value of the high resistance conductive plate.

2. The switch device of claim 1, further comprising a light emitting unit located on the circuit board.

3. The switch device of claim 1, wherein the other end of the at least one elastic part is connected to the lower cover.

4. The switch device of claim 1, wherein the sliding part comprises a pressing portion and an abutting portion connected to the pressing portion, and the abutting portion is configured to abut against the high resistance conductive plate, such that the high resistance conductive plate generates the deformation.

5. The switch device of claim 4, wherein the pressing portion passes through a through hole of the high resistance conductive plate, and the abutting portion is located over the high resistance conductive plate.

6. The switch device of claim 5, wherein the at least one elastic part comprises two springs, and the through hole is located between the two springs.

7. The switch device of claim 1, wherein the high resistance conductive plate is located between the at least one elastic part and the sliding part.

8. The switch device of claim 1, wherein the other end of the at least one elastic part is connected to the sliding part.

9. The switch device of claim 1, wherein the sliding part comprises a pressing portion and an abutting portion connected to the pressing portion, and the abutting portion is configured to abut against the high resistance conductive plate by the at least one elastic part, such that the high resistance conductive plate generates the deformation.

10. The switch device of claim 9, wherein the abutting portion is located over the high resistance conductive plate.

11. The switch device of claim 9, wherein the sliding part further comprises a shaft body connected to the abutting portion, and the shaft body passes through the at least one elastic part.

12. The switch device of claim 1, wherein the high resistance conductive plate comprises two supporting portions disposed on the lower cover and a deforming portion connected between the two supporting portions, and the sliding part abuts against the deforming portion by the at least one elastic part.

13. The switch device of claim 12, wherein the deforming portion is connected to a top portion of the two supporting portions.

14. A switch device, comprising:
a lower cover disposed on a circuit board;
an upper cover disposed on the lower cover, and the upper cover and the lower cover forming an accommodating space;
a sliding part passing through the upper cover and configured to slide relative to the upper cover along a direction;
at least one elastic part located in the accommodating space; and
a high resistance conductive plate connected to an end of the at least one elastic part, and the high resistance conductive plate receiving a pressing force from the sliding part and generating a deformation, wherein the deformation enables a resistance value of the high resistance conductive plate to vary,
wherein the high resistance conductive plate generates a switch signal in response to the deformation, and the switch signal is between a pressed state and a non-pressed state.

15. The switch device of claim 14, wherein the sliding part comprises a pressing portion and an abutting portion connected to the pressing portion, and the abutting portion is configured to abut against the high resistance conductive plate, such that the high resistance conductive plate generates the deformation.

16. The switch device of claim 15, wherein the pressing portion passes through a through hole of the high resistance conductive plate, and the abutting portion is located over the high resistance conductive plate.

17. The switch device of claim 14, wherein the sliding part comprises a pressing portion and an abutting portion connected to the pressing portion, and the abutting portion is configured to abut against the high resistance conductive plate by the at least one elastic part, such that the high resistance conductive plate generates the deformation.

18. The switch device of claim 17, wherein the abutting portion is located over the high resistance conductive plate.

19. The switch device of claim 14, wherein the high resistance conductive plate comprises two supporting portions disposed on the lower cover and a deforming portion connected between the two supporting portions, and the sliding part abuts against the deforming portion by the at least one elastic part.

20. The switch device of claim 19, wherein the deforming portion is connected to a top portion of the two supporting portions.
